(19) United States
(12) Patent Application Publication
(10) Pub. No.: US 2001/0004255 A1
(43) Pub. Date: Jun. 21, 2001

(54) Liquid crystal display drive circuit which can drive normally white type liquid crystal panel and normally black type liquid crystal panel

(75) Inventor: Kouichi Nishimura, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/732,690

(22) Filed: Dec. 8, 2000

(30) Foreign Application Priority Data
Dec. 17, 1999 (JP) 358992/1999

(51) Int. Cl. G09G 5/00

(52) U.S. Cl. 345/204

(57) ABSTRACT

A liquid crystal display driving circuit is provided with a first amplifier unit, a second amplifier unit, a first bias voltage source, a second bias voltage source, and a bias switch. The first amplifier unit receives a γ corrected negative type image signal or a γ corrected positive type image signal. The second amplifier unit receives the positive type image signal when the first amplifier unit receives the negative type image signal or the negative type image signal when the first amplifier unit receives the positive type image signal. The first bias voltage source generates a first bias voltage. The second bias voltage source generates a second bias voltage. The bias switch applies the first bias voltage to the first amplifier unit when the second bias voltage is applied to second amplifier unit or the second bias voltage to the first amplifier unit when the first bias voltage is applied to the second amplifier unit.

### BACKGROUND OF THE INVENTION

1. Field of the Invention

The present invention relates to a liquid crystal drive circuit for driving a TFT (Thin Film Transistor) type liquid crystal panel.

2. Description of the Related Art

A TFT type liquid crystal panel is driven by a liquid crystal drive circuit. The TFT type liquid crystal panel is driven by the liquid crystal drive circuit under an alternate current. As the drive of the alternative drive, there are a plurality of drive manners. The drive of the alternate current implies a frame inversion drive, a gate line inversion drive (line inversion drive), a drain line inversion drive (row inversion drive) or a dot inversion drive. Japanese Laid Open Patent Application (JP-A-H06-222741) and Japanese Laid Open Patent Application (JP-A-H10-293560) disclose a technique with regard to the liquid crystal drive circuit.

FIG. 1 shows the configuration of the conventional liquid crystal drive circuit. A liquid crystal drive circuit 10 shown in FIG. 1 carries out the dot inversion drive. The liquid crystal drive circuit 10 is provided with a LCD signal process circuit 20 and a gain amplifier 30. The gain amplifier 30 has amplifiers 31 to 34 and a bias voltage source 35.

An output of the LCD signal process circuit 20 is connected to inputs of the gain amplifier 30 (the amplifiers 31 to 34). Outputs of the gain amplifier 30 (the amplifiers 31 to 34) are connected to a horizontal analog driver HAD (not shown) of the liquid crystal panel.

The LCD signal process circuit 20 has a γ correction circuit (not shown) for performing a γ correction process on a picture signal. The LCD signal process circuit 20 generates a negative picture signal and a positive picture signal, in accordance with an output signal (picture signal) from the γ correction circuit. The gain amplifier 30 (the amplifiers 31 to 34) receives a negative drive signal and a positive drive signal outputted by the LCD signal process circuit 20. The gain amplifier 30 generates a negative drive picture signal and a positive drive picture signal, which are changed with a voltage (COM) of the bias voltage 35 as a center.

FIG. 2 shows the configuration of the conventional LCD signal process circuit. An LCD signal process circuit 100 (20) shown in FIG. 2 is provided with a clamp circuit (CL) 110, a γ correction circuit 120, a sample holding circuit 130, a polarity inversion circuit 140, a selector circuit 150 and a buffer circuit 160. The sample holding circuit 130 is composed of first to eighth sample holding devices (S/H) 131 to 138. The polarity inversion circuit 140 is composed of first to eighth polarity inversion circuits (REV) 141 to 148. The selector circuit 150 is composed of first to fourth selector devices (SECT) 151 to 154. The buffer circuit 160 is composed of first to fourth buffer devices (BUF) 161 to 164.

An output of the clamp circuit 110 is connected to an input of the γ correction circuit 120. An output of the γ correction circuit 120 is connected to inputs of the first to eighth sample holding devices 131 to 138. Outputs of the first to eighth sample holding devices 131 to 138 are connected to inputs of the first to eighth polarity inversion devices 141 to 148. Outputs of the first to eighth polarity inversion devices 141 to 148 are connected to inputs of the first to fourth selector devices 151 to 154. Outputs of the first to fourth selector devices 151 to 154 are connected to the first to fourth buffer devices 161 to 164.

The clamp circuit 110 reproduces the direct current components of an inputted analog input picture signal IN. The γ correction circuit 120 performs a γ correction on the picture signal.

The first to eighth sample holding devices 131 to 138 perform a sampling operation and a holding operation on the picture signal outputted by the γ correction circuit 120 at predetermined timings. The timings of the sampling operation and the holding operation in the first to eighth sample holding devices 131 to 138 are controlled by a shift register (not shown) mounted on the input sides of the first to eighth sample holding circuits 131 to 138.

The shift register sequentially turns on the first to eighth sample holding devices 131 to 138, synchronously with a dot clock signal generated at a constant timing. For example, the shift register, when receiving a first pulse of the dot clock signal with certain timing as a standard, turns on the first sample holding device 131. The first sample holding device 131, when turned on by the shift register, carries out the sampling operation, and holds a sampling data until receiving a new turn-on instruction. The shift register, when receiving a second pulse of the dot clock signal, turns on the second sample holding device 132. The second sample holding device 132, when turned on by the shift register, carries out the sampling operation, and holds a sampling data until receiving a new turn-on instruction. The shift register, when receiving the third to eighth pulses, sequentially turns on the third to eighth sample holding devices 133 to 138. The third to eighth sample holding devices 131 to 138 carry out the sampling operation and the holding operation. The shift register, when receiving the ninth pulse, again turns on the first sample holding device 131. The first sample holding device 131 newly carries out the sampling operation and the holding operation.

Output periods of the first to eighth sample holding devices 131 to 138 are set to ¼that of the γ correction circuit 120. In the first to eighth sample holding devices 131 to 138, serial picture signals are corrected into parallel picture signals.

The first to eighth polarity inversion devices 141 to 148 refer to an inversion standard voltage (IVRV) and a polarity inversion signal (PIVS), and generate the negative picture signals and the positive picture signals from the picture signals outputted by the first to eighth sample holding devices 131 to 138.

The first to fourth selectors 151 to 154 read in the picture signals outputted by the first to fourth polarity inversion devices 141 to 144, or read in the picture signals outputted by the fifth to eighth polarity inversion devices 145 to 148. The first to fourth buffer devices 161 to 164 store the picture signals outputted by the first to fourth selector devices 151 to 154. The first to fourth buffer devices 161 to 164 output first to fourth output signals OUT1 to OUT4 (negative picture signals and positive picture signals) to the amplifiers 31 to 34. The reading periods of the first to fourth selectors 151 to 154 and the buffering periods of the first to fourth buffer devices 161 to 164 are set to ¼of a repetition period of the dot clock signal.

FIG. 3 shows an operation timing of the conventional LCD signal process circuit 100. The shift register refers to dot clock signals C1 to C19 shown in FIG. 3. The polarity inversion signal IVS (PIVS) is sent to the first to eighth polarity inversion devices 141 to 148.

The shift register turns on the first sample holding device 131 at the timings of the dot clock signals C1, C9 and C17. The turned on first sample holding device 131 carries out the sampling operation. The first sample holding device 131 holds a sampling data until new turn-on timing. The shift register turns on the second sample holding device 132 at the timings of the dot clock signals C2, C10 and C18. The turned on second sample holding device 132 carries out the sampling operation. The second sample holding device 132 holds a sampling data until new turn-on timing. The shift register turns on the third sample holding device 133 at the timings of the dot clock signals C3, C11 and C19. The turned on third sample holding device 133 carries out the sampling operation. The third sample holding device 133 holds a sampling data until new turn-on timing. Similarly, the fourth to eighth sample holding devices 134 to 138 are turned on at the timings of the dot clock signals C4 to C8, C12 to C16 and C19, and carry out the sampling operations and the holding operations.

The first to fourth selector devices 151 to 154 select the outputs of the first to fourth polarity inversion devices 141 to 144 synchronously with the timings of the dot clocks C5, C13. The first to fourth selector devices 151 to 154 select the outputs of the fifth to eighth polarity inversion devices 145 to 148 synchronously with the timings of the dot clocks C9, C17.

Picture signals DATA1 to DATA4 are generated in a first period while a timing inversion signal IVS indicates a high level, with certain timing as a standard. Picture signals DATA5 to DATA8 are generated in a second period while the timing inversion signal IVS indicates a low level. Picture signals DATA9 to DATA12 are generated in a third period while the timing inversion signal IVS again indicates the high level. Picture signals DATA13 to DATA16 are generated in a fourth period while the timing inversion signal IVS again indicates the low level.

The picture signals DATA1 to DATA4 in the first period are sampled and held in the first to fourth sample holding devices 141 to 144. The picture signals DATA5 to DATA8 in the second period are sampled and held in the fifth to eighth sample holding devices 145 to 148. The picture signals DATA9 to DATA12 in the third period are sampled and held in the first to fourth sample holding devices 141 to 144. The picture signals DATA13 to DATA16 in the fourth period are sampled and held in the fifth to eighth sample holding devices 145 to 148. The picture signals DATA17 to DATA20 in the fifth period are sampled and held in the first to fourth sample holding devices 141 to 144.

The first to fourth selectors 151 to 154 receive the picture signals DATA1 to DATA4 held in the first to fourth sample-holding devices 141 to 144 from the first to fourth polarity inversion circuits 141 to 144. At this time, the first and third polarity inversion circuits 141, 143 generate the positive picture signals. At this time, the second and fourth polarity inversion circuits 142, 144 generate the negative picture signals. The first to fourth buffer devices 161 to 164 buffer the picture signals DATA1 to DATA4, and then output.

The first to fourth selectors 151 to 154 receive the picture signals DATA5 to DATA8 held in the fifth to eighth sample holding devices 145 to 148 from the fifth to eighth polarity inversion circuits 145 to 148. At this time, the fifth and seventh polarity inversion circuits 145, 147 generate the positive picture signals. At this time, the sixth and eighth polarity inversion circuits 146, 148 generate the negative picture signals. The first to fourth buffer devices 161 to 164 buffer the picture signals DATA5 to DATA8, and then output.

The first to fourth selectors 151 to 154 receive the picture signals DATA9 to DATA12 held in the first to fourth sample-holding devices 141 to 144 from the first to fourth polarity inversion circuits 141 to 144. At this time, the first and third polarity inversion circuits 141, 143 generate the positive picture signals. At this time, the second and fourth polarity inversion circuits 142, 144 generate the negative picture signals. The first to fourth buffer devices 161 to 164 buffer the picture signals DATA9 to DATA12, and then output.

The first to fourth selectors 151 to 154 receive the picture signals DATA13 to DATA16 held in the fifth to eighth sample holding devices 145 to 148 from the fifth to eighth polarity inversion circuits 145 to 148. At this time, the fifth and seventh polarity inversion circuits 145, 147 generate the positive picture signals. At this time, the sixth and eighth polarity inversion circuits 146, 148 generate the negative picture signals. The first to fourth buffer devices 161 to 164 buffer the picture signals DATA13 to DATA16, and then output.

FIG. 4 shows an operational waveform of the conventional liquid crystal drive circuit 10. FIG. 4 shows an operational waveform when the liquid crystal drive circuit 10 drives a normally white type liquid crystal panel. The left side of FIG. 4 shows the combination of a first output picture signal OUT1 in the first period inputted to the gain amplifier 30 and a first output picture signal OUT1 in a second period.

The right side of FIG. 4 shows the combination of a first amplification picture signal in a first period outputted from the gain amplifier 30 and a first amplification picture signal in a second period after an elapse of 1 H from a start of the first period.

A first amplification picture signal at a first timing in the first period corresponds to a first output picture signal OUT1 at the first timing in the first period. A first amplification picture signal at a first timing in the second period corresponds to a first output picture signal OUT1 at the first timing in the second period.

The polarity of the first output picture signal OUT1 is inverted at a first timing in a second period (phase 2) after an elapse of one horizontal period (1 H) from a first timing in a first period (phase 1). In order to attain this polarity inversion, the first picture signal OUT1 at the first timing in the second period is generated in accordance with the negative picture signal (the second amplification picture signal) obtained through a second sample holding device 62. Here, the period while the first picture signal OUT1 indicates the positive picture signal is referred to as the phase 1, and the period while the first picture signal OUT1 indicates the negative picture signal is referred to as the second phase 2.

When the second period is started, first to fourth selectors 71 to 74 read in a picture signal composed of the combination of the second to fifth sample holding devices 62 to 65 and the combination of the sixth to first sample holding devices 66 to 61. The target read by the first selector 71 is changed at each time a new period appears.

When a third period (phase 1) is started, the first selector 71 again starts the reading operation from the first sample holding device 61. When a fourth period (phase 2) is started, the first selector 71 again starts the reading operation from the second sample holding device 62.

During a certain period, if the first output picture signal OUT1 indicates the negative picture signal (NP), a second output picture signal OUT2 indicates the positive picture signal (PP). If the first output picture signal OUT1 indicates the positive picture signal, the second output picture signal OUT2 indicates the negative picture signal. If a third output picture signal OUT3 indicates the negative picture signal, a fourth output picture signal OUT4 indicates the positive picture signal. If the third output picture signal OUT3 indicates the positive picture signal, the fourth output picture signal OUT4 indicates the negative picture signal.

A voltage change area generated by the negative output picture signal and the positive output picture signal shown in FIG. 4 has a dynamic range of 4 V (+2 V, −2 V) in which a standard voltage VBIAS 3.59 V is used as a standard. The negative output picture signal and the positive output picture signal are amplified in a dynamic range of about 13.2 V. The negative amplification picture signal and the positive amplification picture signal are amplified in a voltage change area between 0 V and 13.2 V with a standard voltage of 6.6 V as a center. The ranges between 0 V and 1.3 V (BL) and between 11.9 V and 13.2 V are established in order to absorb a disable band of the gain amplifier 30. A potential difference of 3 V is established between an upper limit (WH) of the negative amplification picture signal and a lower limit of the positive amplification picture signal.

If the liquid crystal drive circuit 10 drives a normally black type liquid crystal panel, the changes of the wave forms in the negative output picture signal and the positive output picture signal are inverted.

In the conventional liquid crystal drive circuit 10, a dynamic range (a voltage change width in which a signal can be accommodated) on an input side generated by the positive output picture signals and the negative output picture signals inputted to the gain amplifier 30 is similar to a dynamic range (a voltage change width in which a signal can be accommodated) on an output side generated by the positive and negative amplification picture signals outputted by the gain amplifier 30.

The wider dynamic range on the input side requires a higher power supply voltage corresponding to its dynamic range. If the power supply voltage is set to be higher, it is difficult to reduce a consumptive electric power.

The conventional liquid crystal drive circuit 10, when driving the normally white type liquid crystal panel and when driving the normally black type liquid crystal panel, requires a process for inverting the changes of the wave forms in the negative output picture signal and the positive output picture signal. In order to carry out the process, this requires a two-system signal process circuit, which results in a complex circuit.

### SUMMARY OF THE INVENTION

The present invention provides a liquid crystal drive circuit for attaining a small electric power and a simplification of a circuit configuration.

A liquid crystal display driving circuit according to the invention is provided with a first amplifier unit (310,330), a second amplifier unit (320,340), a first bias voltage source (352), a second bias voltage source (353), and a bias switch (351). The first amplifier unit (310,330) receives a γ corrected negative type image signal or a γ corrected positive type image signal. The second amplifier unit (320,340) receives the positive type image signal when the first amplifier unit (310,330) receives the negative type image signal or the negative type image signal when the first amplifier unit (310,330) receives the positive type image signal. The first bias voltage source (352) generates a first bias voltage. The second bias voltage source (353) generates a second bias voltage. The bias switch (351) applies the first bias voltage to the first amplifier unit (310,330) when the second bias voltage is applied to second amplifier unit (320,340) or the second bias voltage to the first amplifier unit (310,330) when the first bias voltage is applied to the second amplifier unit (320,340).

Another liquid crystal display driving circuit according to the invention is provided with a first sample-hold circuit unit (61,63,65,67) and a second sample-hold circuit unit (62,64,66,68). The first sample-hold circuit unit (61,63,65,67) samples the negative type image signal and the positive type image signal (62,64,66,68) which are inputted to the first amplifier unit (310,330) and hold a sampled image signal. The second sample-hold circuit unit (62,64,66,68) samples the negative type image signal and the positive type image signal which are inputted to the second amplifier unit (320,340) and hold a sampled image signal. The first amplifier unit (310,330) receives the negative type image signal and the positive type image signal via the first sample-hold circuit unit (61,63,65,67), and the second amplifier unit (320,340) receives the negative type image signal and the positive type image signal via the second sample-hold circuit unit (62,64,66,68).

In another liquid crystal display driving circuit according to the invention, the negative type image signal and the positive type image signal is applied to the first amplifier unit (310,330) at a predetermined constant timing.

In another liquid crystal display driving circuit, the predetermined constant timing is synchronized with a timing at which the negative type image signal or the positive type image signal is applied to the first amplifier unit (310,330).

In another liquid crystal display driving circuit according to the invention, the first output voltage of the first amplifier unit (310,330) and a second output voltage of the second amplifier unit (320,340) have a same voltage deviating range. The first bias voltage set the first output voltage to a one voltage deviating range. the second bias voltage set to the second output voltage to another voltage deviating range.

Another liquid crystal display driving circuit according to the invention is provided with a pole inverting circuit (52). The pole inverting circuit 52 generates the negative type image signal based on an negative type γ corrected signal and the positive type image signal based on a positive type γ corrected signal.

In another liquid crystal display driving circuit according to the invention, the bias switch (351) switches a applying object for the first bias voltage and the second bias voltage at every 1 H timing.

In another liquid crystal display driving circuit, the bias switch (351) switches a applying object for the first bias voltage and the second bias voltage at every one frame timing.

In another liquid crystal display driving circuit according to the invention, the negative type image signal and the positive type image signal are applied to the first amplifier unit (310,330) at a predetermined constant timing.

In another liquid crystal display driving circuit according to the invention, the predetermined constant timing is synchronized with a timing at which the negative type image signal or the positive type image signal is applied to the first amplifier unit (310,330).

Another liquid crystal display driving circuit according to the invention is provided with an amplifier unit, a first bias voltage source, a second bias voltage source and a bias switch. The amplifier unit receives a γ corrected negative type image signal or a γ corrected positive type image signal. The first bias voltage source generates a first bias voltage. The second bias voltage source generates a second bias voltage. The bias switch applies the first bias voltage to the first amplifier unit when the second bias voltage is applied to second amplifier unit or the second bias voltage to the first amplifier unit when the first bias voltage is applied to the second amplifier unit.

A method of driving a liquid crystal display according to the invention is provided with a generating a γ corrected negative type image signal or a γ corrected positive type image signal. The method is further provided with a generating a first bias voltage and a second bias voltage. The method is further provided with an applying the first bias voltage to a first amplifier unit when the second bias voltage is applied to a second amplifier unit. The method is further provided with an applying the second bias voltage to the first amplifier unit when the first bias voltage is applied to the second amplifier unit.

Another method of driving a liquid crystal display according to the invention is provided with a sampling the negative type image signal and the positive type image signal which are inputted to the first amplifier unit and holding a sampled image signal. The method is further provided with a sampling the negative type image signal and the positive type image signal which are inputted to the second amplifier unit and holding a sampled image signal. The method is further provided with a receiving the negative type image signal and the positive type image signal via the first sample-hold circuit unit. The method is further provided with a receiving the negative type image signal and the positive type image signal via the second sample-hold circuit unit.

Another method of driving a liquid crystal display according to the invention is provided with a applying negative type image signal and the positive type image signal to the first amplifier unit at a predetermined constant timing.

In another method of driving a liquid crystal display, the predetermined constant timing is synchronized with a timing at which the negative type image signal or the positive type image signal is applied to the first amplifier unit.

In the another method of driving a liquid crystal display circuit, a first output voltage of the first amplifier unit and a second output voltage of the second amplifier unit first have a same voltage deviating range. Furthermore, the first bias voltage set the first output voltage to a one voltage deviating range and the second bias voltage set to the second output voltage to another voltage deviating range.

### BRIEF DESCRIPTION OF THE DRAWINGS

FIG. 1 is a view showing a configuration of a conventional liquid crystal drive circuit;

FIG. 2 is a view showing a configuration of a conventional LCD signal process circuit;

FIG. 3 is a view showing an operational timing of the conventional LCD signal process circuit;

FIG. 4 is a view showing an operational waveform of a conventional liquid crystal drive circuit;

FIG. 5 is a view showing a configuration of a liquid crystal drive circuit according to the present invention;

FIG. 6 is a view showing a configuration of an amplifier according to the present invention;

FIG. 7 is a view showing a configuration of a bias switch according to the present invention;

FIG. 8 is a view showing a configuration of an LCD signal process circuit according to the present invention;

FIG. 9 is a view showing a first operational waveform of the liquid crystal drive circuit according to the present invention;

FIG. 10 is a view showing a second operational wave form of the liquid crystal drive circuit according to the present invention; and

FIG. 11 is a view showing a configuration of another LCD signal process circuit according to the present invention.

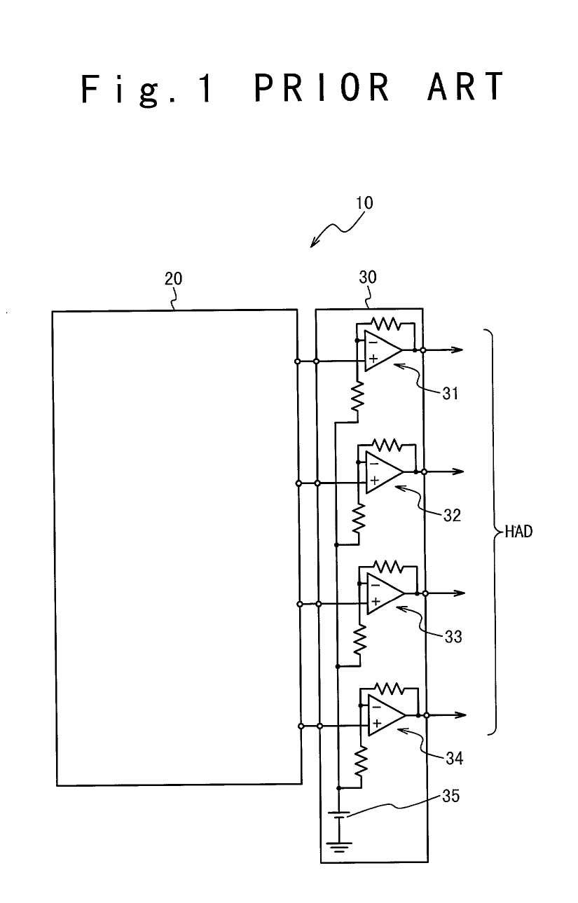

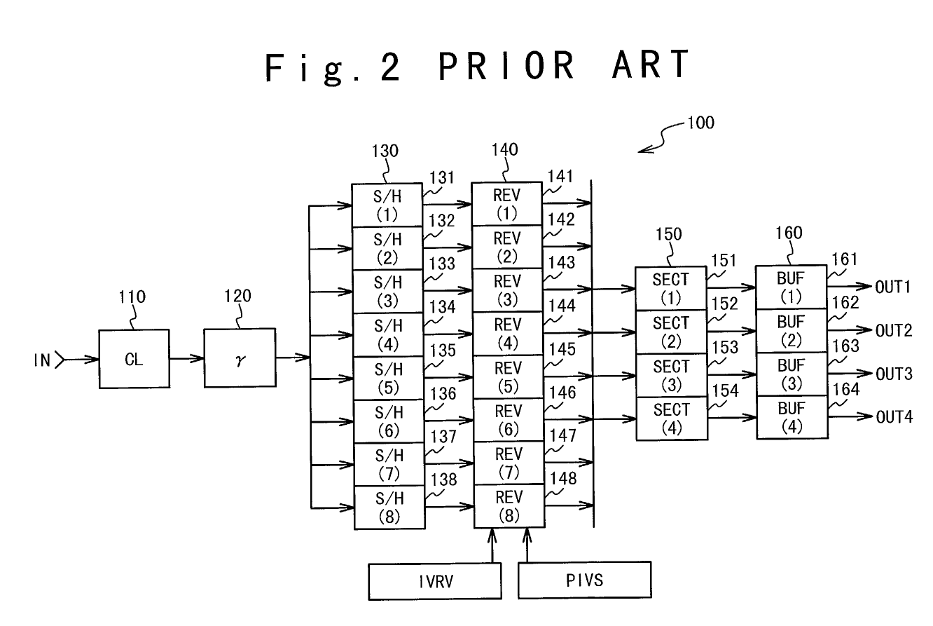

### DESCRIPTION OF THE PREFERRED EMBODIMENT

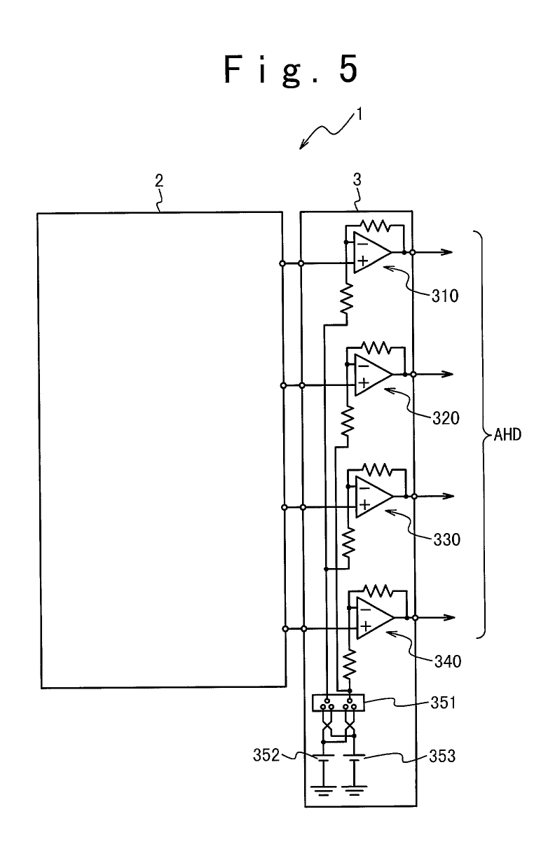

FIG. 5 shows the configuration of a liquid crystal drive circuit according to the present invention. A liquid crystal drive circuit 1 shown in FIG. 5 carries out a dot inversion drive. The liquid crystal drive circuit 1 is provided with a LCD signal process circuit 2 and a gain amplifier 3. The gain amplifier 3 is composed of amplifiers 310 to 340, a bias switch 351, a first bias voltage source 352 and a second bias voltage source 353. The amplifiers 310, 320 constitute a first amplifier group according to the present invention. The amplifiers 320, 340 constitute a second amplifier group according to the present invention.

An output of the LCD signal process circuit 2 is connected to inputs of the gain amplifier 3 (the amplifiers 310 to 340). An output of the gain amplifier 3 (the amplifiers 310 to 340) is connected to a horizontal analog driver (not shown) of a liquid crystal panel.

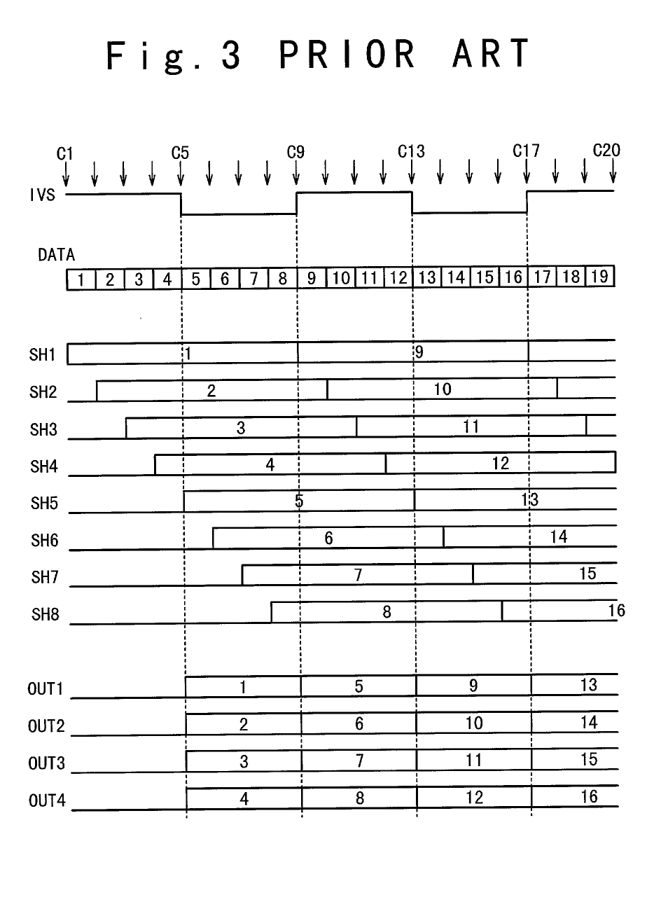

The LCD signal process circuit 2 has a γ correction circuit (not shown) for performing a γ correction process on a picture signal. The LCD signal process circuit 2 generates a negative picture signal and a positive picture signal in accordance with an output signal (picture signal) from the γ correction circuit. The gain amplifier 3 (the amplifiers 310 to 340) receive the negative and positive picture signals outputted by the LCD signal process circuit 2. Timing when the negative or positive picture signal is inputted to each amplifier coincides with the timing described with reference to FIG. 3. The picture signal is inputted to the first to fourth amplifiers 310 to 340, in synchronization with a generation timing of a clock C5. Moreover, a new picture signal is inputted synchronously with a clock C9 generated at a timing after an elapse of a certain period from the generation of the clock C1. After that, new picture signals are inputted synchronously with clocks C13, C17.

The gain amplifier 3 refers to a first bias voltage and a second bias voltage outputted by the bias switch 351, and generates a negative drive picture signal and a positive drive picture signal. The bias switch 351 applies the same bias voltage to the odd-numbered amplifiers (the first amplifier group: the first amplifier 310 and the third amplifier 330). The bias switch 351 applies the same bias voltage to the even-numbered amplifiers (the second amplifier group: the second amplifier 320 and the fourth amplifier 340). The bias switch 351, when applying the first bias voltage to the odd-numbered amplifiers, applies the second bias voltage to the even-numbered amplifiers. The bias switch 351, when applying the second bias voltage to the odd-numbered amplifiers, applies the first bias voltage to the even-numbered amplifiers. A set value of the first bias voltage is higher than that of the second bias voltage. The actual values of the first and second bias voltages will be described later.

The bias switch 351 carries out a switching operation in synchronization with a constant timing (a repetition period of 1 H) corresponding to one horizontal period of the liquid crystal panel driven by the liquid crystal drive circuit 1 according to the present invention. This constant timing can be suitably changed in accordance with a display manner of the liquid crystal panel. The liquid crystal drive circuit 1 can drive the normally white type liquid crystal panel and the normally black type liquid crystal panel.

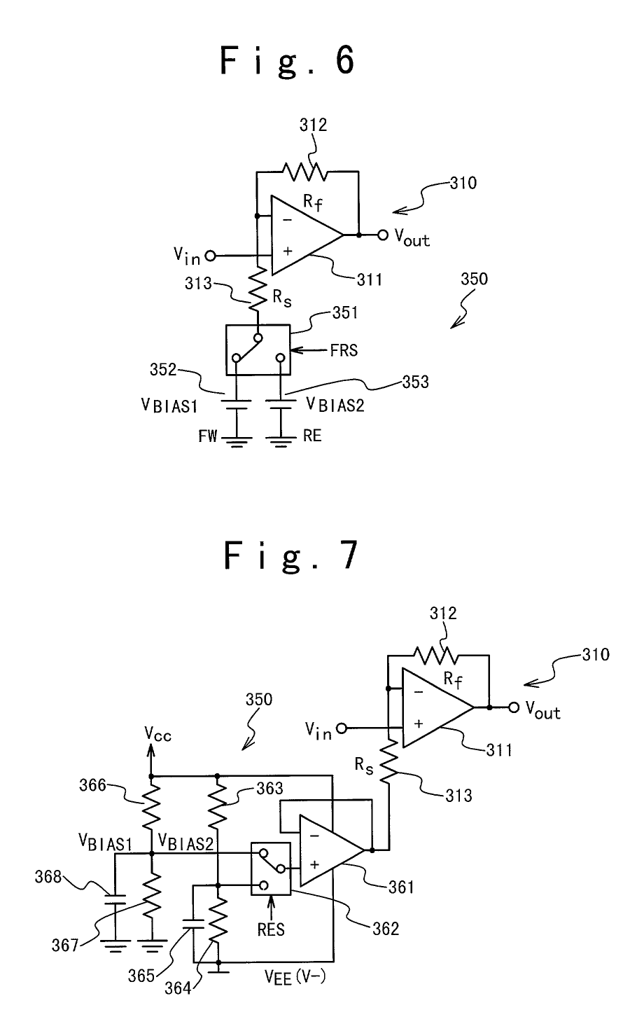

FIG. 6 shows the configuration of the amplifier according to the present invention. The amplifier 310 shown in FIG. 6 is composed of an amplifying device 311 and resistors 312, 313. A bias circuit 350 shown in FIG. 6 is composed of the bias switch 351, the first bias voltage source 352 (VBIAS1) and the second bias voltage source 353 (VBIAS2). The first bias voltage source 352 is used for a forwarding drive (FW). The second bias voltage source 353 is used for a reversing drive (RE).

A+input of the amplifying device 311 is connected to the LCD signal process circuit. One input of the amplifying device 311 is connected to one end of the resisters 312, 313. An output of the amplifying device 311 is connected to the other end of the resistor 312. The other end of the resistor 313 is connected to an output of the bias switch 351. A first input of the bias switch 351 is connected to the first bias voltage source 352. A second input of the bias switch 351 is connected to the second bias voltage source 353. The odd-numbered amplifier (the third amplifier 330) is connected to the output of the bias switch 351. The bias switch 351 is controlled by a synchronous signal (FRS).

The bias switch 351 shown in FIG. 6 represents only the configuration with regard to the odd-numbered amplifying device. The bias switch 351 has the configuration with regard to the even-numbered amplifying device. This configuration carries out the process in which when the first bias voltage source 352 is connected to the odd-numbered amplifier, the second bias voltage source 353 is connected to the even-numbered amplifier, and when the second bias voltage source 353 is connected to the odd-numbered amplifier, the first bias voltage source 352 is connected to the even-numbered amplifier.

FIG. 7 shows the configuration of the bias switch according to the present invention. A bias switch 350 shown in FIG. 7 is provided with an amplifying device 361, a switch 362, resistors 363, 364, a condenser 365, resistors 366, 367 and a condenser 368.

A+input of the amplifying device 361 is connected to an output of the switch 362. A−input of the amplifying device 361 is connected to an output of the amplifying device 361. The output of the amplifying device 361 is connected to the other end of a resistor 313. A first input of the switch 362 is connected to one end of the condenser 368. The other end of the resistor 366 is connected to a comparison input of the amplifying device 361. A power supply voltage Vcc is applied to the other end of the resistor 366. The other end of the resistor 367 and the other end of the condenser 368 are grounded. A second input of the switch 362 is connected to one end of the resistors 363, 364. The second input of the switch 362 is connected to one end of the condenser 365. The other end of the resistor 363 is connected to the other end of the resistor 366. The other end of the resistor 364 is connected to a standard input of the amplifying device 361. The other end of the condenser 365 is connected to the other end of the resistor 364. A minus potential VEE is applied to the other end of the resistor 364. The switch 362 is controlled by a reversing signal (RES).

The switch 362 carries out a switching operation in synchronization with a timing (1 H) when one horizontal period is changed.

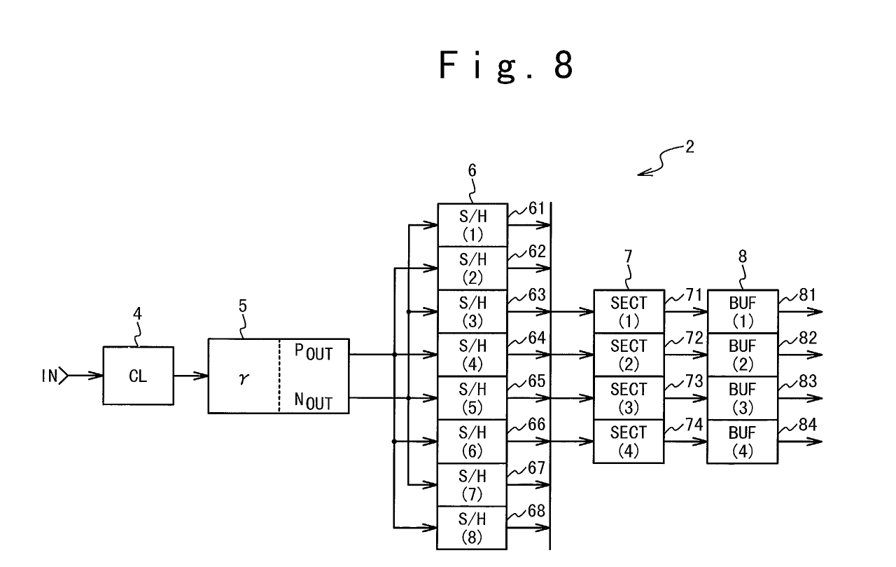

FIG. 8 shows the configuration of the LCD signal process circuit according to the present invention. The LCD signal process circuit 2 shown in FIG. 8 is provided with a clamp circuit 4, a γ correction circuit 5, a sample holding circuit 6, a selector circuit 7 and a buffer circuit 8. The sample holding circuit 6 is composed of first to eighth sample holding devices (S/H) 61 to 68. The selector circuit 7 is composed of first to fourth selector devices (SECT) 71 to 74. The buffer circuit 8 is composed of first to fourth buffer devices (BUF) 81 to 84.

An output of the clamp circuit 4 is connected to an input of the γ correction circuit 5. A first output (Pout) of the γ correction circuit 5 is connected to inputs of the first, third, fifth and seventh sample holding devices 61, 63, 65 and 67. A second output (Nout) of the γ correction circuit 5 is connected to inputs of the second, fourth, sixth and eighth sample holding devices 62, 64, 66 and 68 Outputs of the first to eighth sample holding devices 61 to 68 are connected to inputs of the first to The fourth selector devices 71 to 74. Outputs of the first to fourth selector devices 71 to 74 are connected to the first to fourth buffer devices 81 to 84.

The clamp circuit 4 reproduces the direct current components of an inputted analog input picture signal IN. The γ correction circuit 5 performs the γ correction on the picture signal. The γ correction circuit 5 generates a negative picture signal and a positive picture signal. The first to eighth sample holding devices 61 to 68 sample and hold a positive picture signal and a negative picture signal outputted by a γ correction circuit 120 at a predetermined timing. The first to eighth sample holding devices 61 to 68 divide the positive picture signal and the negative picture signal outputted by the γ correction circuit 5 into four elements. The first to eighth sample holding devices 61 to 68 convert a serial signal into a parallel signal. The first to fourth selectors 151 to 154 read in the positive picture signals and the negative picture signals outputted by the first to fourth sample holding devices 61 to 64 or read in the positive picture signals and the negative picture signals outputted by the fifth to eighth sample holding devices 65 to 68. The first to fourth buffer devices 81 to 84 are the interface for buffering the coupling of the first to fourth selector devices 71 to 74 and the first to fourth amplifiers 310 to 340. The first to fourth buffer devices 81 to 84 output first to fourth output picture signals OUT1 to OUT4 to the first to fourth amplifiers 310 to 340.

The LCD signal process circuit 2 is operated synchronously with signal timing shown in FIG. 3. A positive polarity and a negative polarity are set for the signals which are sampled and held by the first to eighth sample holding circuits 61 to 68.

Picture signals DATA1 to DATA4 at a first timing in a first period (phase 1) are sampled by the first to fourth sample holding devices 61 to 64. The picture signals DATA1, DATA3 sampled by the first and third sample holding devices 61, 63 are composed of the positive picture signals. The picture signals DATA2, DATA4 sampled by the second and fourth sample holding devices 62, 64 are composed of the negative picture signals.

Picture signals DATA5 to DATA8 at a second timing in the first period (phase 1) are sampled by the fifth to eighth sample holding devices 61 to 68. The picture signals DATA5, DATA7 sampled by the fifth and seventh sample holding devices 65, 67 are composed of the positive picture signals. The picture signals DATA6, DATA8 sampled by the sixth and eighth sample holding devices 66, 68 are composed of the negative picture signals.

Picture signals DATA9 to DATA12 at a third timing in the first period (phase 1) are sampled by the first to fourth sample holding devices 61 to 68. The picture signals DATA9, DATA11 sampled by the first and third sample holding devices 61, 63 are composed of the positive picture signals. The picture signals DATA10, DATA12 sampled by the second and fourth sample holding devices 62, 64 are composed of the negative picture signals.

Picture signals DATA13 to DATA16 at a fourth timing in the first period (phase 1) are sampled by the fifth to eighth sample holding devices 61 to 68. The picture signals DATA13, DATA15 sampled by the fifth and seventh sample holding devices 65, 67 are composed of the positive picture signals. The picture signals DATA14, DATA16 sampled by the sixth and eighth sample holding devices 66, 68 are composed of the negative picture signals.

Picture signals DATA17 to DATA20 at a fifth timing in the first period (phase 1) are sampled by the first to fourth sample holding devices 61 to 68. The picture signals DATA17, DATA19 sampled by the first and third sample holding devices 61, 63 are composed of the positive picture signals. The picture signals DATA18, DATA20 sampled by the second and fourth sample holding devices 62, 64 are composed of the negative picture signals.

The first to fourth selectors 71 to 74 receive the positive picture signals DATA1, DATA3 and the negative picture signals DATA2, DATA4 held by the first to fourth sample holding devices 61 to 64 at the second timing in the first period. The first to fourth selectors 71 to 74 receive the positive picture signals DATA5, DATA7 and the negative picture signals DATA6, DATA8 held by the fifth to eighth sample holding devices 65 to 68 at the third timing in the first period. The first to fourth selectors 71 to 74 receive the positive picture signals DATA9, DATA11 by the first to fourth sample holding devices 61 to 64 at the fourth timing in the first period. The first to fourth selectors 71 to 74 receive the positive picture signals DATA13, DATA15 and the negative picture signals DATA14, DATA16 held by the fifth to eighth sample holding devices 65 to 68 at the fifth timing in the first period.

The first to fourth buffer devices 81 to 84 output the picture signals DATA1 to DATA4 at the second timing in the first period. The first to fourth buffer devices 81 to 84 output the picture signals DATA5 to DATA8 at the third timing in the first period. The first to fourth buffer devices 81 to 84 output the picture signals DATA9 to DATA12 at the fourth timing in the first period. The first to fourth buffer devices 81 to 84 output the picture signals DATA13 to DATA16 at the fifth timing in the first period. The picture signals DATA1 to DATA16 outputted by the first to fourth buffer devices 81 to 84 are received by the gain amplifier 30, as the first to fourth picture signals OUT1 to OUT4.

The LCD signal process circuit 2 reads out from the first to fourth sample holding devices 61 to 64, at the second timing in the first period, and reads in the fifth to eighth sample holding devices 65 to 68. The LCD signal process circuit 2 reads in from the first to fourth sample holding devices 61 to 64, at the third timing in the first period, and reads out the fifth to eighth sample holding devices 65 to 68. The LCD signal process circuit 2 reads in from the first to fourth sample holding devices 61 to 64, at the fourth timing in the first period, and reads out the fifth to eighth sample holding devices 65 to 68. The LCD signal process circuit 2 reads in from the first to fourth sample holding devices 61 to 64, at the fifth timing in the first period, and reads out the fifth to eighth sample holding devices 65 to 68.

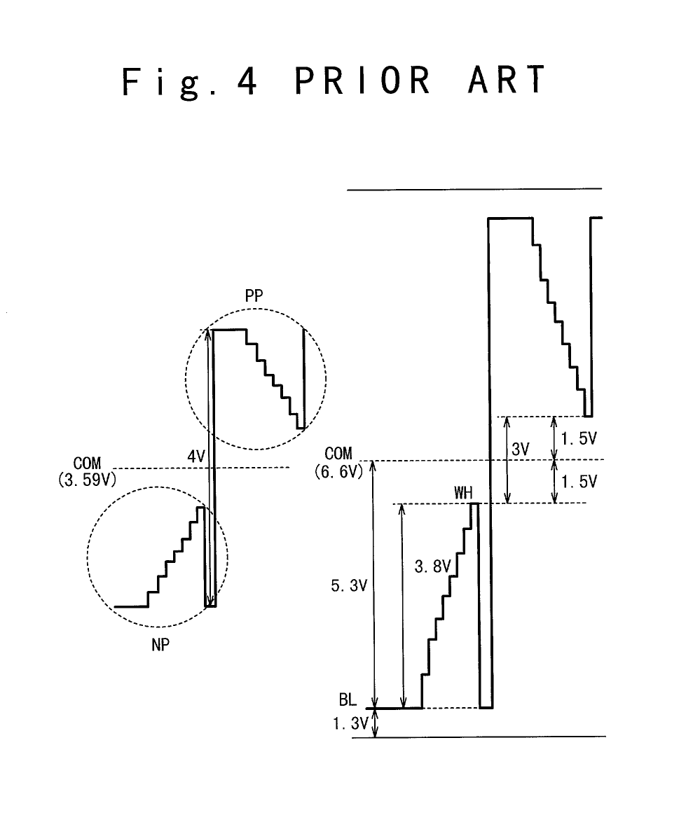

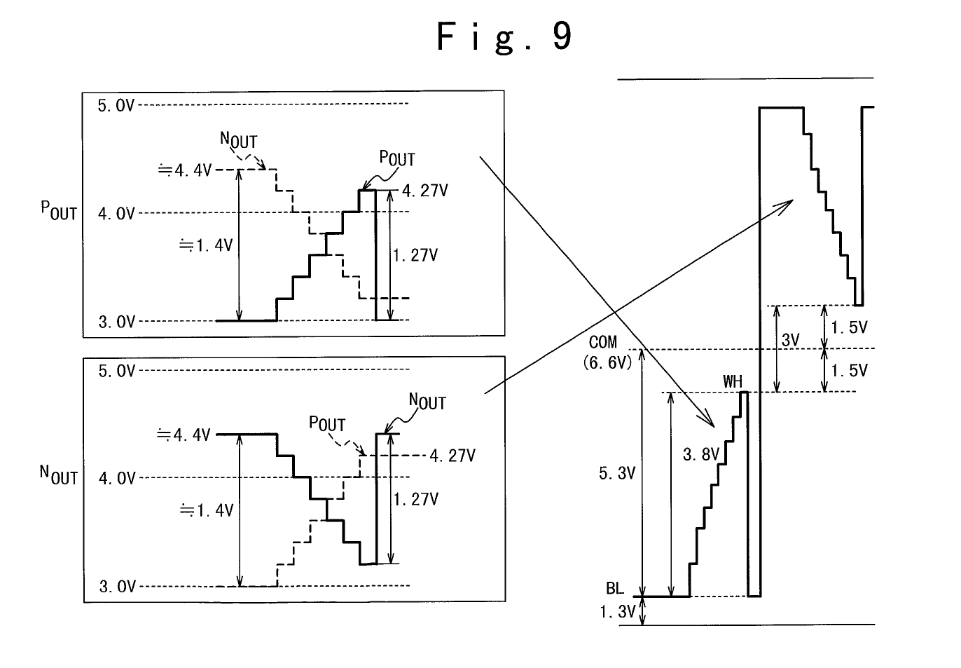

FIG. 9 shows a first operation waveform of the liquid crystal drive circuit 1 according to the present invention. FIG. 9 shows an operation waveform when the liquid crystal drive circuit 1 drives the normally white type liquid crystal panel (TN panel). The left side of FIG. 9 shows the combination of a first output picture signal OUT1 in the first period (having the meaning similar to the explanation in FIG. 4) inputted to the gain amplifier 3 and a first output picture signal OUT1 in the second period (having the meaning similar to the explanation in FIG. 4).

The right side of FIG. 9 shows the combination of a first amplification picture signal at a first timing in a first period (phase 1) outputted from the gain amplifier 3 and a first amplification picture signal at a first timing in a second period (phase 2). The first amplification picture signal at the first timing in the first period corresponds to the first output picture signal OUT1 at the first timing in the first period. The first amplification picture signal at the first timing in the second period corresponds to the first output picture signal OUT1 at the first timing in the second period.

The second period appears after an elapse of one horizontal period (1 H) from a start of the first period. A polarity of the first output picture signal OUT1 is inverted at the first timing in the second period.

A value of a voltage shown in FIG. 9 indicates a typical voltage to be used when the TN panel is driven.

If the first output picture signal OUT1 indicates the positive picture signal, the second output picture signal OUT2 indicates the negative picture signal. If the first output picture signal OUT1 indicates the negative picture signal, the second output picture signal OUT2 indicates the positive picture signal. If a third output picture signal OUT3 indicates the positive picture signal, a fourth output picture signal OUT4 indicates the negative picture signal. If the third output picture signal OUT3 indicates the negative picture signal, the fourth output picture signal OUT4 indicates the positive picture signal.

The negative output picture signal and the positive output picture signal shown in FIG. 9 are accommodated in a voltage change area in which a dynamic range of 2 V (3 to 5 V) is established. The negative output picture signal and the positive output picture signal are amplified and accommodated in a pair of voltage change areas (a negative side voltage change area and a positive side voltage change area) having a dynamic range of about 13.2 V. An amplification picture signal is amplified in a dynamic range between 0 V and 13.2 V with a standard voltage of 6.6 V as a center. The ranges between 0 V and 1.3 V and between 11.9 V and 13.2 V are established in order to absorb a disable band of the gain amplifier 3. A potential difference of 3 V is established between an upper limit of the negative amplification picture signal and a lower limit of the positive amplification picture signal. The negative side voltage change area in which the negative amplification picture signal is accommodated has a dynamic range between 1.3 V and 5.1 V. The positive side voltage change area in which the positive amplification picture signal is accommodated has a dynamic range between 8.1 V and 11.9 V.

The bias switch 351, when driving the normally white type liquid crystal panel, applies the second bias voltage to the odd-numbered amplifiers 310, 330, and applies the first bias voltage to the even-numbered amplifiers 320, 340.

The setting of the bias switch 351 enables the positive picture signal to be positioned in a voltage change area lower than a standard voltage COM (6.6 V), and also enables the negative picture signal to be positioned in a voltage change area higher than the standard voltage COM.

Here, a method for calculating the first bias voltage and the second bias voltage is described. Let us suppose that a voltage of a picture signal inputted to the gain amplifier 3 is Vin, a bias of a drive picture signal outputted by the gain amplifier 3 is VB, a value of a source resistor (resistor 313) of the amplifier is Rs, a value of a feedback resistor (resistor 312) of the amplifier is Rf and an output voltage of the gain amplifier 3 is Vo.

Vo=Vin+(Vin−VB)/Rs*Rf=Vin(1+Rf/Rs)−Rf/Rs*VB

If the gain of the gain amplifier 3 is set to 3, Rs:Rf=1:2 is set. When this setting is substituted for the above-mentioned equation, the following equation is given:

Vo=3*Vin−2*VB

The amplitudes necessary for the positive picture signal and the negative picture signal are 3.8 V/3=1.27 V. Its minimum output voltage is set to 3.0 V.

If the positive picture signal is a voltage of 3.0 V indicative of a black level, the negative drive picture signal must be set to 1.3 V. If the positive picture signal is 4.27 V indicative of a white level, the negative drive picture signal must be set to 5.1 V. A first bias voltage VB1 is calculated in accordance with this condition.

VB1=(3*3.0−1.3)/2=3.85 V

If the negative picture signal is a voltage of 4.4 V indicative of the black level, the positive drive picture signal must be set to 11.9 V (6.6V+1.5 V+3.8 V). A second bias voltage VB2 is calculated in accordance with this condition.

VB2=(3*4.4−11.9)/2=0.65 V

When the one horizontal period is ended, the bias switch 351 is switched. Thus, in a next frame, the second bias voltage VB2 is applied to the odd-numbered amplifier, and the first bias voltage VB1 is applied to the even-numbered amplifier.

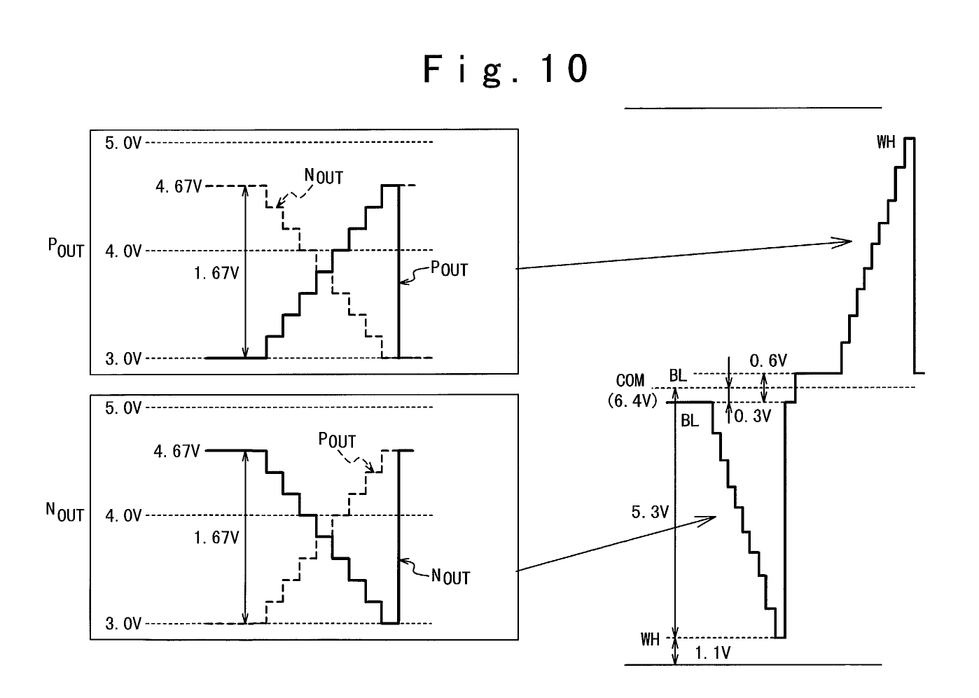

FIG. 10 shows a second operation waveform of the liquid crystal drive circuit 1 according to the present invention. FIG. 10 shows an operation waveform when the liquid crystal drive circuit 1 drives the normally black type liquid crystal panel. The left side of FIG. 10 shows the combination of a first output picture signal OUT1 in the first period (having the meaning similar to the explanation in FIG. 9) inputted to the gain amplifier 3 and a first output picture signal OUT1 in the second period (having the meaning similar to the explanation in FIG. 9).

The right side of FIG. 10 shows the combination of the first amplification picture signal at the first timing in the first period outputted from the gain amplifier 3 and a first amplification picture signal at the first timing in the second period. The first amplification picture signal at the first timing in the first period corresponds to the first output picture signal OUT1 at the first timing in the first period. The first amplification picture signal at the first timing in the second period corresponds to the first output picture signal OUT1 at the first timing in the second period.

The second period implies a timing after an elapse of one horizontal period (1 H) from the start of the first period. The polarity of the first output picture signal OUT1 is inverted when the second period is started.

If the first output picture signal OUT1 indicates the positive picture signal, the second output picture signal OUT2 indicates the negative picture signal. If the first output picture signal OUT1 indicates the negative picture signal, the second output picture signal OUT2 indicates the positive picture signal. If the third output picture signal OUT3 indicates the positive picture signal, the fourth output picture signal OUT4 indicates the negative picture signal. If the third output picture signal OUT3 indicates the negative picture signal, the fourth output picture signal OUT4 indicates the positive picture signal.

The voltage change area generated by the negative output picture signal and the positive output picture signal shown in FIG. 10 has the dynamic range of 2 V (3 to 5 V). The negative output picture signal and the positive output picture signal are amplified in a dynamic range of about 12.8 V. The negative amplification picture signal and the positive amplification picture signal are amplified in a voltage change area between 0 V and 12.8 V with a standard voltage of 6.4 V as a center. The ranges between 0 V and 1.1 V and between 11.7 V and 12.8 V are established in order to absorb the disable band of the gain amplifier 3. A potential difference of 0.6 V is established between the upper limit of the negative amplification picture signal and the lower limit of the positive amplification picture signal.

The bias switch 351, when driving the normally black type liquid crystal panel, applies the first bias voltage to the odd-numbered amplifiers 310, 330, and applies the second bias voltage to the even-numbered amplifiers 320, 340.

The setting of the bias switch 351 enables the positive picture signal to be positioned in a voltage change area higher than a standard voltage COM (6.4 V), and also enables the negative picture signal to be positioned in a voltage change area lower than the standard voltage COM.

Here, a method for calculating the first bias voltage and the second bias voltage is described. If the positive picture signal is the voltage of 3.0 V indicative of the black level, the negative drive picture signal must be set to 6.7 V (6.4+0.3). If the positive picture signal is 4.67 V indicative of the white level, the negative drive picture signal must be set to 11.7 V. The first bias voltage VB1 is calculated in accordance with this condition.

VB1=(3*3.0−6.7)/2=1.15 V

If the negative picture signal is the voltage of 4.67 V indicative of the black level, the positive drive picture signal must be set to 6.1 V (1.1+5.3−0.3). The second bias voltage VB2 is calculated in accordance with this condition.

VB2=(3*4.67−6.1)/2=3.96 V

The bias switch 351 is switched after the elapse of the one horizontal period (1 H). Thus, in a next period, the second bias voltage VB2 is applied to the odd-numbered amplifier, and the first bias voltage VB1 is applied to the even-numbered amplifier.

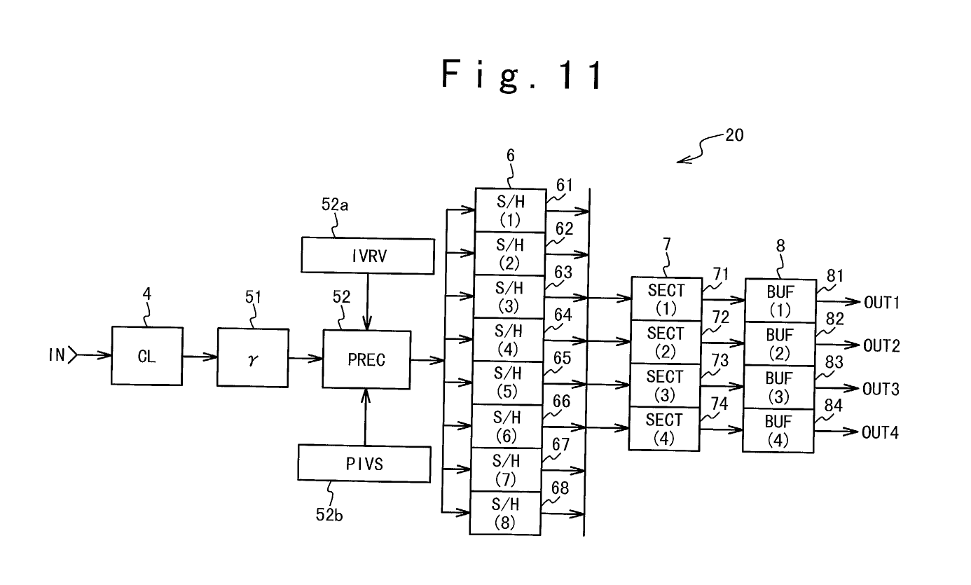

FIG. 11 shows a configuration of another LCD signal process circuit according to the present invention. The circuit shown in FIG. 11 shows the configuration using a γ correction circuit 51 without a function of inverting a polarity. An LCD signal process circuit 20 shown in FIG. 11 is provided with a clamp circuit 4, the γ correction circuit 51, a polarity inversion circuit 52 (PREC), a sample holding circuit 6, a selector circuit 7 and a buffer circuit 8. The sample holding circuit 6 is composed of first to eighth sample holding devices (S/H) 61 to 68. The selector circuit 7 is composed of first to fourth selector devices (SECT) 71 to 74. The buffer circuit 8 is composed of first to fourth buffer devices (BUF) 81 to 84.

The signal process circuit 20 shown in FIG. 11 is different from the signal process circuit 2 shown in FIG. 8 in the configurations of the γ correction circuit 51 and the polarity inversion circuit 52.

The output of the clamp circuit 4 is connected to an input of the γ correction circuit 51. An output of the γ correction circuit 51 is connected to an input of the polarity inversion circuit 52. An output of the polarity inversion circuit 52 is connected to the inputs of the first to eighth sample holding devices 61 to 68. The outputs of the first to eighth sample holding devices 61 to 68 are connected to the inputs of the first to fourth selector devices 71 to 74. The outputs of the first to fourth selector devices 71 to 74 are connected to the first to fourth buffer devices 81 to 84.

The γ correction circuit 51 performs the γ correction on the picture signal. The polarity inversion circuit 52 refers to an inversion standard voltage 52a (IVRV) and a polarity inversion signal 52b (PIVS), and accordingly generates a negative picture signal and a positive picture signal. The polarity inversion signal 52a indicates a standard voltage serving as a standard in the polarity inversion. The polarity inversion signal 52b is changed synchronously with the sampling timings of the first to eighth sample holding devices 61 to 68. The polarity inversion circuit 52 receives an instruction of a positive setting or a negative setting, in synchronization with timing when a sample holding device carrying out the sampling operation is switched. The LCD signal process circuit 20 can output the output signal (output picture signal) similar to that of the LCD signal process circuit 2 shown in FIG. 8.

The present invention is not limited to the above-mentioned embodiments. If the drive frequency of the liquid crystal panel is fixed, the number of circuit devices is increased or decreased in accordance with the number of dots in the liquid crystal panel. The liquid crystal drive circuit described in the embodiment can drive a liquid crystal panel of an XGA standard (1028×768 dots) if the frequency of the picture signal is set to 80 MHz and the drive frequency is set to 20 MHz.

In the liquid crystal drive circuit according to the present invention, the positive picture signal and the negative picture signal are positioned in the same voltage change area. The width of the voltage change area is approximately half the width in the voltage change bands conventionally required to locate the positive picture signal and the negative picture signal. If the width of the voltage change band is made narrower, it is possible to reduce a power supply voltage required to generate the positive picture signal and the negative picture signal. The reduction in the power supply voltage enables the drop in the consumptive electric power.

The liquid crystal drive circuit according to the present invention can drive the normally white type liquid crystal panel and the normally black type liquid crystal panel. The liquid crystal drive circuit according to the present invention does not require the preparation of the two-system signal process circuit, depending on the type of the liquid crystal panel to be driven. The liquid crystal drive circuit according to the present invention has no fear that the circuit becomes complex in order to cope with a plurality of types in the liquid crystal panel.

The present invention can attain the liquid crystal drive circuit whose consumptive electric power is smaller than that of the conventional liquid crystal drive circuit.

What is claimed is:

1. A liquid crystal display driving circuit comprising:
a first amplifier unit receiving a γ corrected negative type image signal or a γ corrected positive type image signal;
a second amplifier unit receiving the positive type image signal when the first amplifier unit receives the negative type image signal or the negative type image signal when the second amplifier unit receives the positive type image signal;
a first bias voltage source generating a first bias voltage;
a second bias voltage source generating a second bias voltage;
a bias switch applying the first bias voltage to the first amplifier unit when the second bias voltage is applied to second amplifier unit or the second bias voltage to the first amplifier unit when the first bias voltage is applied to the second amplifier unit.

2. A liquid crystal display driving circuit as claimed in claim 1 comprising:
a first sample-hold circuit unit sampling the negative type image signal and the positive type image signal which are inputted to the first amplifier unit and holding a sampled image signal; and
a second sample-hold circuit unit sampling the negative type image signal and the positive type image signal which are inputted to the second amplifier unit and holding a sampled image signal,
wherein the first amplifier unit receives the negative type image signal and the positive type image signal via the first sample-hold circuit unit, and the second amplifier unit receives the negative type image signal and the positive type image signal via the second sample-hold circuit unit.

3. A liquid crystal display driving circuit as claimed in claim 1,
wherein the negative type image signal and the positive type image signal is applied to the first amplifier unit at a predetermined constant timing.

4. A liquid crystal display driving circuit as claimed in claim 3,
wherein the predetermined constant timing is synchronized with a timing at which the negative type image signal or the positive type image signal is applied to the first amplifier unit.

5. A liquid crystal display driving circuit as claimed in claim 1,
wherein a first output voltage of the first amplifier unit and a second output voltage of the second amplifier unit first have a same voltage deviating range,
the first bias voltage set the first output voltage to a one voltage deviating range, and
the second bias voltage set to the second output voltage to another voltage deviating range.

6. A liquid crystal display driving circuit as claimed in claim 5 comprising:
a pole inverting circuit generating the negative type image signal based on a negative type γ corrected signal and the positive type image signal based on a positive type γ corrected signal which are generated by a γ converter.

7. A liquid crystal display driving circuit as claimed in claim 6,
wherein the bias switch switches a applying object for the first bias voltage and the second bias voltage at every 1 H timing.

8. A liquid crystal display driving circuit as claimed in claim 6,
wherein the bias switch switches a applying object for the first bias voltage and the second bias voltage at every one frame timing.

9. A liquid crystal display driving circuit as claimed in claim 2,
wherein the negative type image signal and the positive type image signal are applied to the first amplifier unit at a predetermined constant timing.

10. A liquid crystal display driving circuit as claimed in claim 9,
wherein the predetermined constant timing is synchronized with a timing at which the negative type image signal or the positive type image signal is applied to the first amplifier unit.

11. A liquid crystal display driving circuit as claimed in claim 2,
wherein a first output voltage of the first amplifier unit and a second output voltage of the second amplifier unit have a same voltage deviating range,
the first bias voltage set the first output voltage to a one voltage deviating range, and
the second bias voltage set the second output voltage to another voltage deviating range.

12. A liquid crystal display driving circuit as claimed in claim 11 comprising:
a pole inverting circuit generating the negative type image signal and the positive type image signal by arranging a pole to a γ corrected signal which is generated by a γ converter.

13. A liquid crystal display driving circuit as claimed in claim 12,
wherein the bias switch switches a applying object for the first bias voltage and the second bias voltage at every 1 H timing.

14. A liquid crystal display driving circuit as claimed in claim 13,
wherein the bias switch switches a applying object for the first bias voltage and the second bias voltage at every one frame timing.

15. A liquid crystal display driving circuit comprising:
an amplifier unit receiving a γ corrected negative type image signal or a γ corrected positive type image signal;
a first bias voltage source generating a first bias voltage;
a second bias voltage source generating a second bias voltage;
a bias switch applying the first bias voltage to the first amplifier unit when the second bias voltage is applied to second amplifier unit or the second bias voltage to the first amplifier unit when the first bias voltage is applied to the second amplifier unit.

16. A liquid crystal display driving circuit as claimed in claim 15 comprising:
a first sample-hold circuit unit sampling the negative type image signal and the positive type image signal which are inputted to the first amplifier unit and holding a sampled image signal; and
a second sample-hold circuit unit sampling the negative type image signal and the positive type image signal which are inputted to the second amplifier unit and holding a sampled image signal,
wherein the first amplifier unit receives the negative type image signal and the positive type image signal via the first sample-hold circuit unit, and the second amplifier unit receives the negative type image signal and the positive type image signal via the second sample-hold circuit unit.

17. A liquid crystal display driving circuit as claimed in claim 15,
wherein the negative type image signal and the positive type image signal is applied to the first amplifier unit at a predetermined constant timing.

18. A liquid crystal display driving circuit as claimed in claim 17,
wherein the predetermined constant timing is synchronized with a timing at which the negative type image signal or the positive type image signal is applied to the first amplifier unit.

19. A liquid crystal display driving circuit as claimed in claim 15,
wherein a first output voltage of the first amplifier unit and a second output voltage of the second amplifier unit first have a same voltage deviating range,
the first bias voltage set the first output voltage to a one voltage deviating range, and
the second bias voltage set to the second output voltage to another voltage deviating range.

20. A liquid crystal display driving circuit as claimed in claim 16,
wherein the negative type image signal and the positive type image signal is applied to the first amplifier unit at a predetermined constant timing.

21. A liquid crystal display driving circuit as claimed in claim 20,
wherein the predetermined constant timing is synchronized with a timing at which the negative type image signal or the positive type image signal is applied to the first amplifier unit.

22. A liquid crystal display driving circuit as claimed in claim 16:
wherein a first output voltage of the first amplifier unit and a second output voltage of the second amplifier unit first have a same voltage deviating range,
the first bias voltage set the first output voltage to a one voltage deviating range, and
the second bias voltage set to the second output voltage to another voltage deviating range.

23. A liquid crystal display driving circuit as claimed in claim 22 comprising:
a pole inverting circuit generating the negative type image signal and the positive type image signal by arranging a pole to a γ corrected signal which is generated by a γ converter.

24. A liquid crystal display driving circuit as claimed in claim 23,
wherein the bias switch switches a applying object for the first bias voltage and the second bias voltage at every 1 H timing.

25. A liquid crystal display driving circuit as claimed in claim 24,
wherein the bias switch switches a applying object for the first bias voltage and the second bias voltage at every one frame timing.

26. A method of driving a liquid crystal display comprising:
generating a γ corrected negative type image signal or a γ corrected positive type image signal;
generating a first bias voltage;
generating a second bias voltage;
applying the first bias voltage to a first amplifier unit when the second bias voltage is applied to a second amplifier unit; and
applying the second bias voltage to the first amplifier unit when the first bias voltage is applied to the second amplifier unit.

27. A method of driving a liquid crystal display as claimed in claim 26 comprising:
sampling the negative type image signal and the positive type image signal which are inputted to the first amplifier unit and holding a sampled image signal;
sampling the negative type image signal and the positive type image signal which are inputted to the second amplifier unit and holding a sampled image signal;
receiving the negative type image signal and the positive type image signal via the first sample-hold circuit unit; and
receiving the negative type image signal and the positive type image signal via the second sample-hold circuit unit.

28. A method of driving a liquid crystal display as claimed in claim 27 comprising:
applying negative type image signal and the positive type image signal to the first amplifier unit at a predetermined constant timing.

29. A method of driving a liquid crystal display as claimed in claim 28,
wherein the predetermined constant timing is synchronized with a timing at which the negative type image signal or the positive type image signal is applied to the first amplifier unit.

30. A method of driving a liquid crystal display circuit as claimed in claim 28,
wherein a first output voltage of the first amplifier unit and a second output voltage of the second amplifier unit first have a same voltage deviating range,
the first bias voltage set the first output voltage to a one voltage deviating range, and
the second bias voltage set to the second output voltage to another voltage deviating range.
